(19) United States
(12) Patent Application Publication
(10) Pub. No.: US 2015/0242509 A1
(43) Pub. Date: Aug. 27, 2015

(54) Method and System of Crowd Sourcing Data Using Mobile Device

(71) Applicant: InMobi PTE LTD., Singapore (SG)

(72) Inventors: Inderbir Singh Pall, Bangalore (IN); Satish Mittal, Bangalore (IN); Ritwik Saikia, Bangalore (IN); Rohit Kochar, Bangalore (IN)

(73) Assignee: INMOBI PTE LTD., Singapore (SG)

(21) Appl. No.: 14/608,945

(22) Filed: Jan. 29, 2015

(30) Foreign Application Priority Data
Feb. 3, 2014 (IN) 466/CHE/2014

(51) Int. Cl. G06F 17/30; H04L 29/08

(52) U.S. Cl. CPC G06F 17/30864; H04L 67/104

(57) ABSTRACT

The present invention provides a method for performing analysis on crowdsource data using mobile devices. The method comprises the steps of receiving a query specific function, pushing one or more instances of the query specific function for execution to a set of mobile devices, triggering one or more instances of the query specific function to generate one or more crowdsource data sets associated with the set of mobile devices receiving the one or more crowdsource data sets and analyzing the one or more crowdsource data sets according to the query specific function.

### FIELD OF INVENTION

The present invention relates to analysis of crowdsourced data and in particular, it relates to analysis of crowd-sourced data using mobile device.

### BACKGROUND

Crowdsourcing is an act of outsourcing a task to a crowd and has potential to revolutionize the way information is collected and processed. Crowdsourcing enables in-depth, large-scale, cost-effective information gathering, and accurate techniques for information extraction from crowdsource data. However, gathering and analyzing crowdsource data has always been a challenge. Nowadays, mobile phones have various inbuilt sensors, which are useful in gathering the crowdsource data.

Due to widespread usage of the mobile phones for everyday use, the mobile phones offer a great platform to contribute the crowdsource data from a larger contributing crowd, making contribution easier and omnipresent. Further, with the advancement in mobile technology, the mobile phones are getting smarter. The mobile phones are usually equipped with multi sensing capabilities like, geo location, light, movement, audio, and visual sensor. Therefore, analyzing the crowdsource data from the mobile phones is critical to interpret customers' behavior, define target criteria and analyze the crowdsource data to optimize crowdsourcing for maximum results.

In one of the current approaches, batteries of a smartphone are used to crowdsource weather information. In this approach, temperature sensors are built into smartphone batteries to crowdsource weather information. The temperature sensors usually prevent smartphones from dangerously overheating. This approach utilizes the fact that the battery temperatures tell a story about environment around them. However, this approach is application specific and cannot be utilized for crowdsourcing and gathering information in different domains. Moreover, the measurement from the temperature sensors is also dependent on the usage of its processor and tends to give different value than the actual temperature of surrounding.

In another approach, sensors of mobile phones are used to crowdsource noise pollution data from a given area. This approach collects information from microphones, which is either logged locally or sent to a memory server in real-time. A signal processing algorithm computes the sound level that the user is exposed to, by taking audio samples recorded using the phone's microphone. However, this approach is again application specific and cannot be implemented for collecting various other information that can be collected via crowdsourcing.

In light of the above discussion, there is a need for a method and system suitable for wide range of Crowdsourcing, which overcomes all the above stated problems.

### BRIEF DESCRIPTION OF THE INVENTION

The above-mentioned shortcomings, disadvantages and problems are addressed herein which will be understood by reading and understanding the following specification.

In embodiments, the present invention provides a method for performing analysis on crowdsource data. The method comprising the steps of receiving a query specific function, pushing one or more instances of the query specific function for execution to a set of mobile devices, triggering one or more instances of the query specific function to generate one or more crowdsource data sets associated with the set of mobile devices receiving the one or more crowdsource data sets and analyzing the one or more crowdsource data sets according to the query specific function.

In an embodiment, the method further includes determining one or more mobile devices of the set mobile devices according to pre-determined target criteria.

In an embodiment, the method further includes aggregating the received one or more crowdsource data sets.

In an embodiment, one or more crowdsource data sets is generated using a set of sensors associated with the set of mobile devices.

In another aspect, the present invention provides a system for performing analysis on crowdsource data. The system includes a transceiver and one or more processors. The transceiver is configured to receive a query specific function, to push one or more instances of the query specific function for execution to a set of mobile devices and to receive the one or more crowdsource data sets. The one or more processors are configured to trigger one or more instances of the query function to generate one or more crowdsource data sets on the set of mobile devices and to analyze the one or more crowdsource data sets according to the query specific function.

In an embodiment, the one or more processors are further configured to aggregate the received one or more crowdsource data sets.

### BRIEF DESCRIPTION OF THE DRAWINGS

FIG. 1 illustrates a crowdsourcing system for performing analysis on crowdsource data, in accordance with various embodiments of the present invention;

FIG. 2 illustrates a flowchart for performing analysis on crowdsource data, in accordance with various embodiments of the present invention; and

FIG. 3 illustrates a block diagram of a server, in accordance with various embodiments of the present invention.

### DETAILED DESCRIPTION OF THE INVENTION

In the following detailed description, reference is made to the accompanying drawings that form a part hereof and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

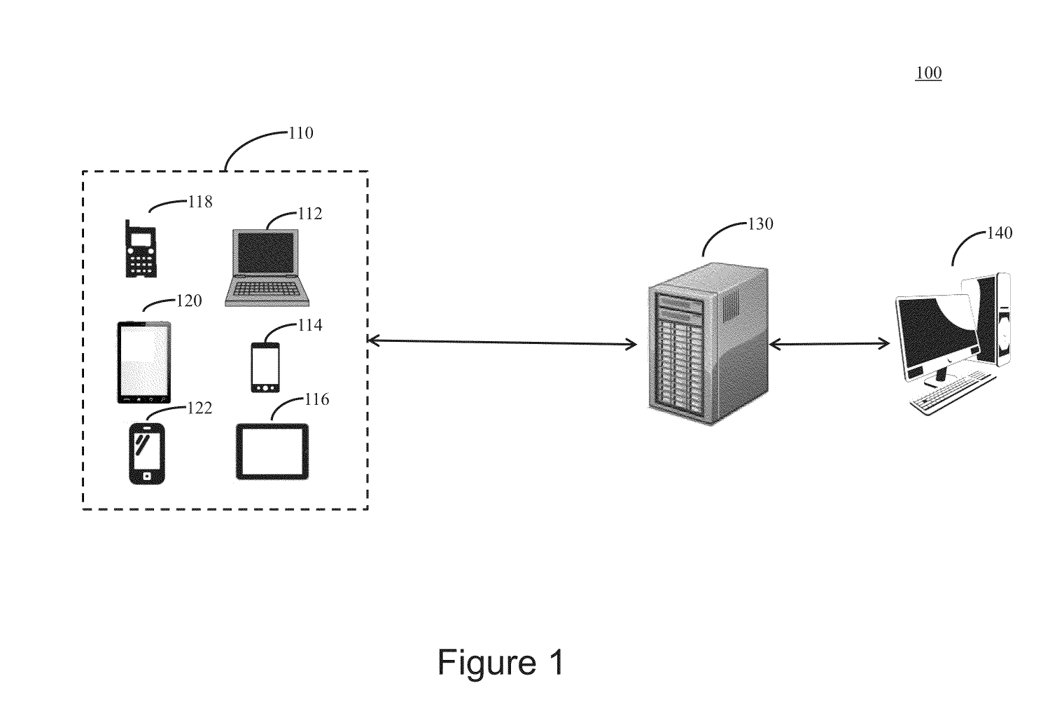

FIG. 1 illustrates a crowdsourcing system 100 for performing analysis on crowdsource data, in accordance with various embodiments of the present invention.

The crowdsourcing system 100 includes a query system 140. In an embodiment, a function is developed on the query system 140 based on a query by a client. In an example, the client gives a query to determine amount of exposure of the crowd to the electromagnetic radiation level. In another example, the client gives a query to find out the regions of a city with more people that are active during the night. Based on the query, a query specific function is developed on the query system 140. Subsequently, the query system 140 transmits the query specific function to a server 130.

The function as described herein refers to a machine readable instruction for processing the one or more variables; the variables being derived from the query provided by the client. The query system 140 is configured to process the query provided by the client into machine readable instructions.

The client as described herein refers to any user of the query system 140, the client may also refer to any application configured to receive query from a user and further transmit it to the query system 140 in an automated manner.

In an embodiment, the server 130 is a web server connected to Internet over a communication network. Examples of types of the communication network include but may not be limited to a local area network, a wide area network, a wireless network, a telecommunication network. On receiving the query specific function, the server 130 transmits the query specific function to a plurality of mobile devices 110. As shown in the FIG. 1, the plurality of the mobile devices 110 includes a mobile device 112, a mobile device 114, a mobile device 116, a mobile device 118, a mobile device 120, and a mobile device 122. Each of the mobile device of the plurality of mobile devices 110 is a part of a crowd that generates crowdsource data. Examples of the each of the mobile device of the plurality of the mobile devices 110 include but may not be limited to, a cell phone, a smart phone, a personal digital assistant (PDA), a wireless email terminal, a laptop, a desktop computer and a tablet computer.

The server 130 communicates with the each of the mobile device of the plurality of the mobile devices 110 over the communication network. Each of the mobile device of the plurality of the mobile devices 110 includes one or more sensors. Examples of the sensor include but may not be limited to, a proximity sensor, a Global Positioning System (GPS) sensor, an ambient light sensor, an accelerometer, a magnetometer, a gyroscope, and a back-illuminating sensor.

The proximity sensor detects the proximity of screen of a mobile device 112 to the user's body. The proximity sensor detects the position of ear with respect to screen of the mobile device 112. Accordingly, the mobile device 112 turns off the light of screen to save battery. Furthermore, the proximity sensor amplifies or filters the signal strength. The ambient light sensor optimizes the light of screen when exposed to normal light with different intensity. The accelerometer senses changes in orientation of the mobile device 112 with respect to datum. Accordingly, the accelerometer adjusts the orientation to suit the viewing angle of the user. The magnetometer makes the mobile device 112 to work as a simple traditional compass. The magnetometer provides a simple orientation in relation to the magnetic field of our Earth. The Global Positioning System (GPS) sensor locates the location of the user by establishing connection of the mobile device 112 with the satellite. The gyroscope maintains and controls the position, level or orientation based on the principle of angular momentum. The back-illuminating sensor uses an arrangement of imaging elements to increase the amount of light captured by a camera of the mobile device 112.

Functions and capabilities of the mobile device 112 are same as the functions and the capabilities of the mobile device 114, the mobile device 116, the mobile device 118, the mobile device 120, and the mobile device 122.

Accordingly, the sensors are capable of generating diverse type of crowdsource data. Referring to the example mentioned in above sections, the magnetometer collects the measure of electromagnetic radiation from each of the mobile device of the plurality of mobile devices 110. In another example mentioned above, the proximity sensor is configured to collect information regarding active users at night. Thereby, the sensors generate the crowdsource data on the each of the mobile device of the plurality of the mobile devices 110 based on the query specific function. The each of the mobile device of the plurality of the mobile devices 110 transmits the generated crowdsource data to the server 130. On receiving the crowdsource data, the server 130 analyzes the crowdsource data.

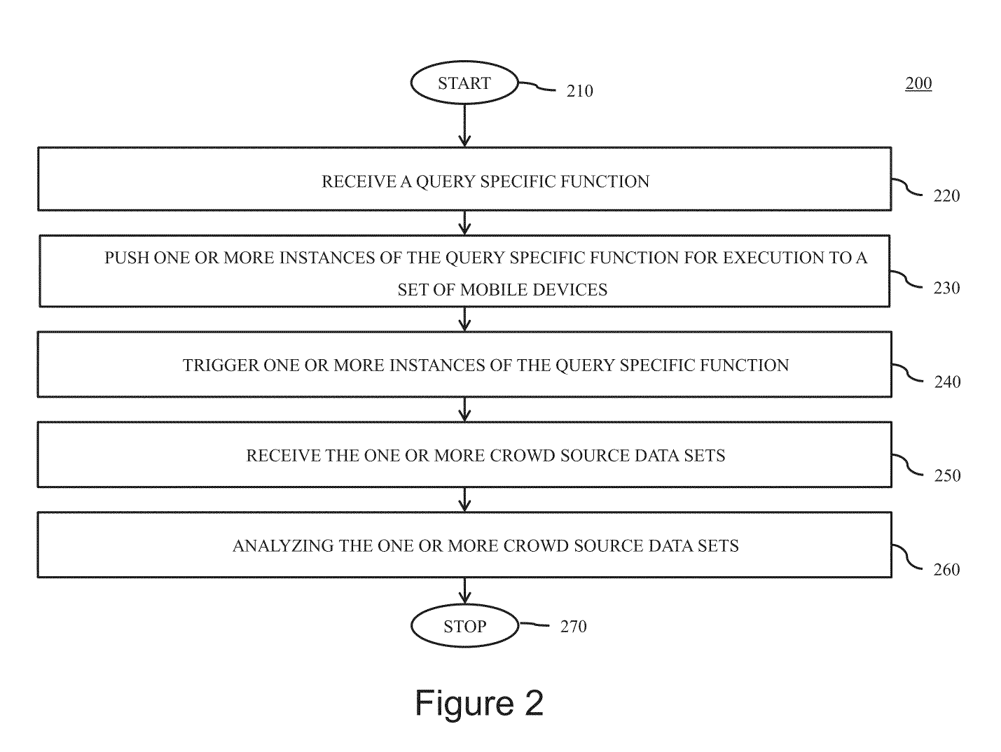

FIG. 2 illustrates a flowchart 200 for performing analysis on the crowdsource data, in accordance with various embodiments of the present invention. At step 210, the flowchart 200 initiates. At step 220, the server 130 receives the query specific function from the query system 140. The query specific function is created on the query system 140 according to the requirement of the client.

Continuing the above-mentioned example, the client sends the query to determine electromagnetic radiation level to which the crowd has been exposed. Further, the query system 140 creates a query specific function based on the query sent by the client. Subsequently, the query system 140 transmits the query specific function to the server 130.

At step 230, the server 130 pushes one or more instances of the query specific function to the each of the mobile device of the plurality of the mobile devices 110 for execution. In an embodiment, one or more instances of an application are installed on the each of the mobile device of the plurality of the mobile devices 110. The application acts as a bridge between the server 130 and the plurality of the mobile devices 110. The application acts as a sandbox, allowing for the execution of the query specific function on the plurality of mobile devices 110. The one or more instances of the application are connected with the server 130 over the communication network.

In another embodiment, the server 130 pushes the one or more instances of the query specific function to the plurality of mobile devices 110 according to pre-determined target criteria. In an example, the pre-determined target criteria refer to a particular telecommunication network to which the plurality of the mobile devices 110 is registered. The server 130 identifies one or more mobile devices of the plurality of mobile devices 110 belonging to the particular telecommunication network using network ID corresponding to the particular telecommunication network. In another example, the pre-determined target criteria refer to a Wireless local Area Network (WLAN) to which the plurality of the mobile devices 110 is connected. The server identifies one or more mobile devices of the plurality of the mobile devices 110 connected to a particular WLAN using the IP range of the WLAN.

At step 240, the server 130 triggers the one or more instances of the query specific function on the each of the mobile device of the plurality of the mobile devices 110 to generate the crowdsource data. In an embodiment, one or more instances of the application download the one or more instances of the query specific function. Subsequently, the one or more instances of the application execute the one or more instances of the query specific function to generate the crowdsource data. In an embodiment, the crowdsource data is generated using the one or more sensors associated with each of the mobile device of the plurality of the mobile devices 110.

Continuing the above-mentioned example, where the client sends the query to determine electromagnetic radiation level to which the crowd has been exposed, the server 130 transmits the query specific function to the plurality of the mobile devices 110. The one or more instances of the application installed on the each of the mobile device of the plurality of the mobile devices 110 download the query specific function. Subsequently, the one or more instances of the application execute the query specific function causing the magnetometer to collect the electromagnetic radiation level associated with the each of the mobile device of the plurality of the mobile devices 110. The readings of the magnetometer are recorded in a time stamp reading format. For example readings of each magnetometer of a plurality of magnetometers over a time-period as given below:

<t1, reading1>

<t2, reading2>

<t1, reading3>

<t2, reading 4>

<t2, reading 5>

<t2. reading 6>

The readings of the each magnetometer of the plurality of magnetometers are collected by the one or more instances of the application. The one or more instances of the application tag the readings of the each magnetometer of the plurality of magnetometers with Global Positioning System (hereinafter GPS) coordinates of the each of the mobile device of the plurality of the mobile devices 110. Subsequently, the one or more instances of the application send the tagged readings to the server 130.

At step 250, the server 130 receives the crowdsource data from the each of the plurality of the mobile devices 110. In an embodiment, the server 130 aggregates the crowdsource data received from the plurality of the mobile devices 110. In an embodiment, the aggregation is based on the time at which the crowdsource data is generated.

Continuing the above-mentioned example, the server 130 receives the magnetometer readings tagged with the GPS coordinates in form of

<GPS1-t1, reading 1> from mobile device 112.

<GPS2-t1, reading 2> from the mobile device 114

<GPS3-t1, reading 3> from the mobile device 116

<GPS4-t1, reading 4> from the mobile device 118

<GPS5-t2, reading 5> from the mobile device 120

<GPS6-t2, reading 6> from the mobile device 122.

The server 130 aggregates the readings of the magnetometer and groups the crowdsource data in various configurations such as within a same geographical area, within a pre-determined span of time and the like. For example, the GPS1, GPS2, GPS3, GPS4, GPS5 and GPS6 readings above aggregated by server 130 are in the same locality and time stamp t1 and time stamp t2 have a difference of 24 hours. The server 130 groups the readings of the one or more magnetometers based on the time stamp t1 and the time stamp t2.

Group1 <GPS-t1> Value <reading 1, reading 2, reading 3, reading 4>

Group1<GPS-t2> Value <reading 5, reading 6>

At step 260, the sever 130 analyzes the aggregated crowdsource data according to the query forwarded by the client. The analysis of the aggregated crowdsource data is done on the server 130.

Continuing from the above-mentioned example, the server 130 performs analysis on the grouped readings of the one or more magnetometers 130. For example, the server 130 calculates an average electromagnetic radiation level.

Group1 <GPS-t1> Value Average<reading1, reading 2, reading 3, reading 4>

Group2 <GPS-t2> Value Average<reading5, reading 6>

In other examples, the server 130 can perform analysis to determine electromagnetic radiation level to which the crowd has been exposed at a particular time of the day. Additionally, the server 130 can perform analysis to determine electromagnetic radiation level to which the crowd has been exposed for a particular type of mobile device.

In an embodiment, an incentive scheme is implemented on the one or more instances of the application installed on the each of the mobile device of the plurality of the mobile devices 110. According to the incentive scheme, the user of gets incentive in the form of virtual credits to share the crowdsource data generated on the mobile device 112 of the user.

At step 270, the flowchart 200 terminates.

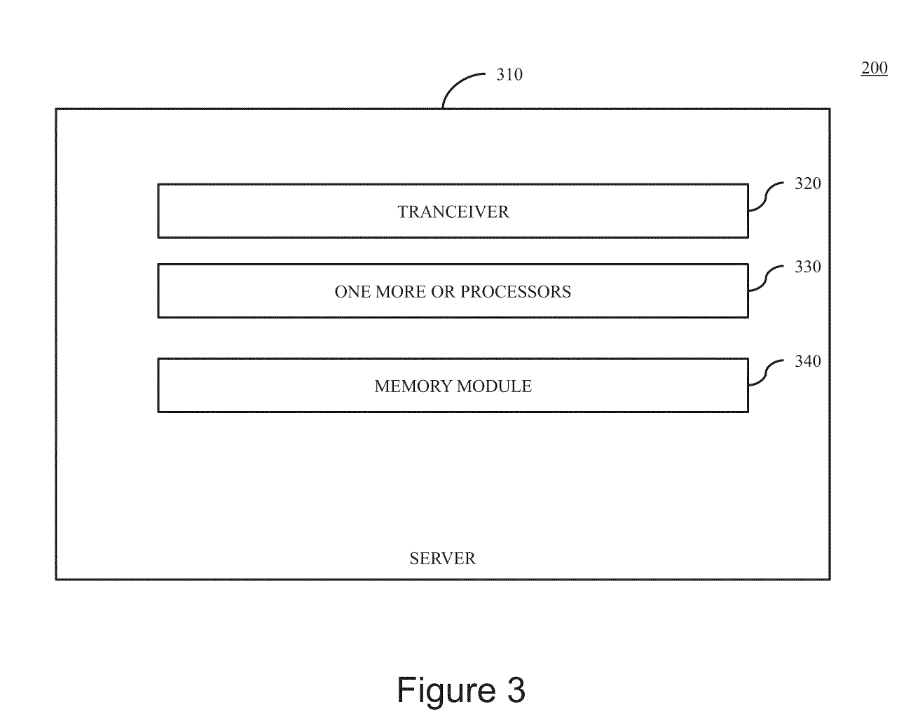

FIG. 3, illustrates a block 300 of the server 310, in accordance with the various embodiments of the present invention. The server 310 includes a transceiver 320, one or more processors 330, and a memory module 340.

The transceiver 320 receives the query specific function from the query system 140. The query specific function is developed on the query system based on the client's query. The memory module 340 coupled to the transceiver stores the query specific function. The transceiver 320 transmits the received query specific function to the plurality of the mobile devices 110. The plurality of the mobile devices 110 are connected to the server 310 over the communication network. The one or more instances of the application installed on the each of the mobile device of the plurality of the mobile devices download the one or more instances of the query specific function.

The one or processors trigger the one or more instances of the application to execute the one or more instances of the query specific function. Subsequently, the one or more instances of the application generate crowdsource data. In an embodiment, the one or more instances of the application generate the crowdsource data using the sensors of the each of the mobile device of the plurality of the mobile devices.

The transceiver 320 receives the generated crowdsource data from the each of the mobile device of the plurality of the mobile devices 110. The memory module 340 coupled with the transceiver 320 stores the generated crowdsource data. In an embodiment, the one or processors 330, coupled to the memory module 340, aggregate the received crowdsource data from the plurality of the mobile devices 110. On aggregation, the one or more processors analyze the crowd source data based on the clients query.

The present invention utilizes the sensors present in today's decently configured smartphones to generate a crowd source data. The present invention is an efficient tool to carry out well-targeted surveys and market research. Moreover, the ability to develop a custom code for client's query makes it possible for the present invention to be implemented on various application domains. Furthermore, the present invention makes it possible to generate crowdsource data using all the current sensors present on the mobile device. Additionally, the present invention also provides a scope to work with all the sensors that could be installed on the mobile device in future.

This written description uses examples to describe the subject matter herein, including the best mode and to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of performing analysis on crowdsource data, the method comprising:
receiving a query specific function;
b) pushing one or more instances of the query specific function for execution to a set of mobile devices;
c) triggering one or more instances of the query specific function to generate one or more crowdsource data sets associated with the set of mobile devices:
d) receiving the one or more crowdsource data sets and
e) analyzing the one or more crowdsource data sets according to the query specific function.

2. The method of claim 1, wherein the method further comprises determining one or more mobile devices of the set mobile devices according to a pre-determined target criteria.

3. The method of claim 1, wherein analyzing the one or more crowdsource data sets further comprises aggregating the received one or more crowdsource data sets.

4. The method of claim 1, wherein the one or more crowdsource data sets is generated using a set of sensors associated with the set of mobile devices.

5. A system for performing analysis on a crowdsource data, the system comprising:
a transceiver, wherein the transceiver is configured to:
i) receive a query specific function;
ii) push one or more instances of the query specific junction for execution to a set of mobile devices; and
iii) receive the one or more crowdsource data sets;
b) one or more processors, wherein the one or more processors are configured to:
i) trigger one or more instances of the query function to generate one or more crowdsource data sets on the set of mobile devices; and
ii) analyze the one or more crowdsource data sets according to the query specific function.

6. The system of claim 5, wherein the one or more processors are further configured to aggregate the received one or more crowdsource data sets.

7. The system of claim 5, wherein the one or processors are further configured to determine one or more mobile devices of the set mobile devices according to pre-determined target criteria.
